(19) United States
(12) Patent Application Publication
(10) Pub. No.: US 2017/0118151 A1
(43) Pub. Date: Apr. 27, 2017

(54) ZapBack

(71) Applicant: Rachelli Cohen, Woodmere, NY (US)

(72) Inventor: Rachelli Cohen, Woodmere, NY (US)

(21) Appl. No.: 14/918,900

(22) Filed: Oct. 21, 2015

(51) Int. Cl. H04L 12/58

(52) U.S. Cl. CPC H04L 51/12

(57) ABSTRACT

The disclosed herein provides a computer-implemented method for recalling an already sent electronic message over a communication network using user equipment. The method comprises of identifying the electronic message previously sent over the communication network, determining a first target to which the electronic message was previously sent, deploying a first agent to the first target, receiving, by the user equipment, an indication to recall the electronic message previously sent over the communication network, at least one restriction to the electronic message, wherein use of the electronic message is in accordance with the at least one restriction, responding to receiving the indication to recall the electronic message previously sent over the communication network, and attaching, via the user equipment, at least one restriction to the electronic message, wherein use of the electronic message is in accordance with the at least one restriction.

### CROSS REFERENCE TO RELATED APPLICATIONS

Not applicable.

### FEDERALLY SPONSORED RESEARCH AND DEVELOPMENT

Not applicable.

### MICROFICHE

Not applicable

### BACKGROUND OF THE INVENTION

(1) Field of the Invention

The present application relates to communication systems and, more particularly, to techniques for managing objects sent in such communication systems.

(2) Background

As is well known, exchanging electronic messages, such as emails or texts, over a communication system has become a preferred mode of communication for individuals in both business and social settings. However, sometimes people send messages and afterwards, for whatever reason, wish they had not sent the message (e.g., the message was sent mistakenly, impulsively, etc.). Some communication systems allow a sender to recall a sent message. For example, the Google® (Mountain View, Calif.) email system known as Gmail® allows a user to recall a sent message within a predetermined time period, e.g., five seconds, if the user configured his/her email settings to do so. However, this does not solve the problem when the predetermined time period has passed, and particularly when the sent message has already been received by a recipient of the message. The Microsoft® (Redmond, Wash.) email system known as Outlook® also allows the recall of a sent message, but only if the message has not yet been read by a recipient.

A common mistake, such as forgetting to attach files, making typos, and clicking send to soon, are common in electronic messages. Senders usually discover their mistakes after messages have already been sent. Some email applications (e.g., IBM® Lotus Notes, Microsoft® Office, etc.) allow sent messages to be recalled if the messages have not been read. Recalled messages are deleted from recipients' inboxes. Senders have to send additional messages to correct mistakes. If a message cannot be recalled, a recipient will have two versions of the message in their inbox.

Once a message is received at a destination, recipients can copy, print, and forward the message. Some communication systems allow a sender to configure a message as one that cannot be copied or printed. As such, a recipient who receives the message can only read the message, but cannot perform standard operations, such as copying, forwarding, or printing.

There is no consensus among current email systems as how to handle a recalled message that has already been read by a recipient. To implement recall, typical e-mail systems forward a message to an intended recipient indicating the message recall. If the recipient has already read the message, in many cases, the message is removed from the recipient's inbox without the recipient's involvement. This can be of great annoyance to the recipient. Alternatively, if the message has already been opened, the message may not be removed.

### BRIEF SUMMARY OF THE INVENTION

The primary objective of the present invention is to provide a computer-implemented method for recalling an already sent electronic message over a communication network using user equipment. The invention provides the ability to unsend a test message or email on any messaging platform available in handheld devices, such as smartphones, etc.

In a preferred embodiment, the method to provide a computer-implemented method for recalling an already sent electronic message over a communication network using a user equipment includes identifying the electronic message previously sent over the communication network, determining a first target to which the electronic message was previously sent, deploying a first agent to the first target, receiving, by the user equipment, an indication to recall the electronic message previously sent over the communication network, at least one restriction to the electronic message, wherein use of the electronic message is in accordance with the at least one restriction and responding to receiving the indication to recall the electronic message previously sent over the communication network, and attaching, via the user equipment, at least one restriction to the electronic message, wherein use of the electronic message is in accordance with the at least one restriction.

Furthermore, according to the invention, upon deploying the first agent to the first target, the first agent is configured to recall the previously sent electronic message at the first target and determines if the previously sent object was sent from the first target to a second target.

Furthermore, in a preferred embodiment, the message is an email message or a text message. Also, according to the invention, the restriction prevents printing of the message, forwarding the message, exporting the message, reading the message, or any one of the above.

In another embodiment of the invention, the computer-implemented method for recalling an already sent electronic message with at least one restriction is comprised of an expiration time. If a recipient of the message has accessed the message, the message is deleted upon elapse of the expiration time. Also, the expiration time can be determined in the user equipment.

In yet another embodiment, the computer-implemented method for recalling an already sent electronic message provides a means to schedule sending of a message form user equipment to the first target and the second target.

The summary is provided to introduce a selection of concepts, in a simplified form, that are further described below in the detailed description. This summary is not intended to identify key features or essential features of the subject matter, nor is it intended to be used as an aid in determining the scope of the subject matter. In this respect, before explaining at least one embodiment of the invention in detail, it is to be understood that the invention is not limited in its application to the details of construction and to the arrangements of the components set forth in the following description. The invention is capable of other embodiments, and of being practiced and carried out in various ways. Also, it is to be understood that the phraseology and terminology employed herein are for the purpose of description, and should not be regarded as limiting. These, together with other objectives of the invention and the various features of novelty that characterize the invention, are pointed out with particularity in the disclosure.

### DETAILED DESCRIPTIONS OF THE INVENTION

The following is a detailed description of example embodiments of the invention. The example embodiments are in such detail as to clearly communicate the invention. However, the amount of detail offered is not intended to limit the anticipated variations of embodiments. On the contrary, the intention is to cover all modifications, equivalents, and alternatives falling within the spirit and scope of the present invention. The detailed descriptions below are designed to make such embodiments obvious to a person of ordinary skill in the art.

The present invention can be implemented on any communication device that has hardware components that can perform wireless and wired communication, such as (but not limited to)—multi-purpose pocket computers, personal multimedia devices, etc.

The various devices on which the applications that implement the present invention run may use one or more processors with different instruction-sets, architectures, clock-speeds, etc., and memory, which may include high speed random access memory and non-volatile memory, such as one or more magnetic disk storage devices, flash memory devices, and other kinds of solid state memory devices.

The various applications that can implement the present invention run on electronic devices that may use at least one physical user interface device that provides the means of control and navigation within the operating system. Applications that run on the devices include (but are not limited to) touch-pads, such as those described in (but not limited to)—(1) U.S. patent application Ser. No. 10/722,948 (“Touch pad for handheld device”, filed Nov. 25, 2003); (2) U.S. patent application Ser. No. 10/188,182 (“Touch pad for handheld device”, filed Mar. 21, 2006); (3) U.S. patent application Ser. No. 08/210,610 (“Computer system with touchpad support in operating system”, filed Mar. 18, 1994); (4) U.S. patent application Ser. No. 643,256 (“Movable touch pad with added functionality”, filed Ser. No. 10/643,256), touch screens, such as those described in (but not limited to) (1) U.S. patent application Ser. No. 11/381,313, “Multipoint Touch Surface Controller,” filed on May 2, 2006; (2) U.S. patent application Ser. No. 10/840,862, “Multipoint Touchscreen,” filed on May 6, 2004; (3) U.S. patent application Ser. No. 10/903,964, “Gestures For Touch Sensitive Input Devices,” filed on Jul. 30, 2004; (4) U.S. patent application Ser. No. 11/048,264, “Gestures For Touch Sensitive Input Devices,” filed on Jan. 31, 2005; (5) U.S. patent application Ser. No. 11/038,590, “Mode-Based Graphical User Interfaces For Touch Sensitive Input Devices,” filed on Jan. 18, 2005; (6) U.S. patent application Ser. No. 11/228,758, “Virtual Input Device Placement On A Touch Screen User Interface,” filed on Sep. 16, 2005; (7) U.S. patent application Ser. No. 11/228,700, “Operation Of A Computer With A Touch Screen Interface,” filed on Sep. 16, 2005; (8) U.S. patent application Ser. No. 11/228,737, “Activating Virtual Keys Of A Touch-Screen Virtual Keyboard,” filed on Sep. 16, 2005 and (9) U.S. patent application Ser. No. 11/367,749, “Multi-Functional Hand-Held Device,” filed on Mar. 3, 2006, click wheels, such as those described in U.S. patent application Ser. No. 11/549,619 “Method, device, and graphical user interface for dialing with a click wheel” filed on Oct. 13, 2006, keyboards, such as those mentioned in (but not limited to) U.S. patent application Ser. No. 07/711,760 (“Ergonomic keyboard input device”, filed on Jun. 6, 1991), mouse, such as those described in (but not limited to) (1) application Ser. No. 09/167,314 (“Computer mouse with enhance control button (s)”, filed on Oct. 6, 1998); (2) application Ser. No. 08/288,945 (“Roller mouse for implementing scrolling in windows applications”, filed on Aug. 10, 1994) and gesture recognition means, such as those described in (but not limited to) (1) European Patent application publication number: EP2482176 A2 (“Multi-input gesture control for a display screen”, filed on Nov. 4, 2011) and (2) U.S. Patent application with publication number 20120317511 A1 (“DISPLAY WITH BUILT IN 3D SENSING CAPABILITY AND GESTURE CONTROL OF TV”, filed on Aug. 21, 2012).

Display means used by these devices may use LCD (liquid crystal display) technology, LED (light Emitting Diode) technology, CRT (Cathode ray tube) technology, LPD (light emitting polymer) technology, or any other display technologies. Various realizations of graphics display circuitry that implement a Graphics Processing Unit (GPU) are used to achieve video interface between the user and these electronic devices.

Connectivity of these devices with networks, such as the Internet, an intranet and/or wireless network, such as cellular telephone network, a wired or wireless local area network (LAN) and/or metropolitan area network (MAN) and/or WAN (wide area network), and other wireless communication, is achieved by use of a plurality of communication standards, protocols, and technologies, such as Bluetooth, Wireless Fidelity (Wi-Fi), and/or any other suitable communication protocol, including communication protocols not yet developed as of the filing date of this document.

The present invention maybe implemented on applications that run on a single or variety of operating system platforms, including but not limited to OS X, WINDOWS, UNIX, IOS, ANDROID, SYMBIAN, LINUX, or embedded operating systems, such as VxWorks.

Having multiple versions of a message in a recipient's inbox may lead to confusion. For example, the recipient received an email about a meeting that specifies an incorrect date. After the recipient read the email, the recipient received another email correcting the date. If the recipient does not delete the incorrect email, the recipient may accidentally use to the incorrect email to reference the date and attend the meeting on the wrong day. Functionality can be implemented in email applications to allow sent messages to be updated, even if the sent messages have been read. When a request to update a sent message is received, a message update unit can update information in the message according to the notification. The message update unit can notify a recipient that the message was updated, and can indicate changed information in the sent message. The message update unit can also determine if the sent message has been forwarded, and forward the update notification to other recipients.

To solve the above problem in a conventional e-mail system, it is an objective of the present invention to provide an e-mail system that allows a mail sender to delete or edit the mail message that the sender has already sent.

To achieve the above objective, the invention provides a method for recalling an already sent electronic message over a communication network using a user equipment. The method comprises of identifying the electronic message previously sent over the communication network, determining a first target to which the electronic message was previously sent, deploying a first agent to the first target, receiving, by the user equipment, an indication to recall the electronic message previously sent over the communication network, at least one restriction to the electronic message, wherein use of the electronic message is in accordance with the at least one restriction and responding to receiving the indication to recall the electronic message previously sent over the communication network, attaching, via the user equipment, at least one restriction to the electronic message, wherein use of the electronic message is in accordance with the at least one restriction. Furthermore, the first agent is configured to recall previously sent electronic messages at the first target and determines if the previously sent object was sent from the first target to a second target. The message is an email message or a text message. Also, according to the invention, the restriction prevents printing of the message, forwarding the message, exporting the message, reading the message, or any one of the above.

In another embodiment of the invention, the computer-implemented method for recalling an already sent electronic message with at least one restriction comprises of an expiration time. If a recipient of the message has accessed the message, the message is deleted upon elapse of the expiration time. Also, the expiration time can be determined in the user equipment. The method provides a means to schedule sending the message form user equipment to the first target and the second target.

Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention

I claim:

1. A computer-implemented method for recalling an already sent electronic message over a communication network using user equipment, said method comprising:
identifying said electronic message previously sent over said communication network,
determining a first target to which said electronic message was previously sent,
deploying a first agent to said first target, wherein said first agent is configured to:
recall said previously sent electronic message at said first target and determine if said previously sent object was sent from said first target to a second target,
receiving, by said user equipment, an indication to recall said electronic message previously sent over said communication network,
at least one restriction to said electronic message, wherein use of said electronic message is in accordance with said at least one restriction, and
responding to receiving said indication to recall said electronic message previously sent over said communication network, attaching, via said user equipment, at least one restriction to said electronic message, wherein use of said electronic message is in accordance with said at least one restriction.

2. The computer-implemented method for recalling an already sent electronic message in accordance with claim 1, wherein said message is an email message.

3. The computer-implemented method for recalling an already sent electronic message in accordance with claim 1, wherein said message is a text message.

4. The computer-implemented method for recalling an already sent electronic message in accordance with claim 1, wherein said at least one restriction prevents printing said message.

5. The computer-implemented method for recalling an already sent electronic message in accordance with claim 1, wherein said at least one restriction prevents forwarding said message.

6. The computer-implemented method for recalling an already sent electronic message in accordance with claim 1, wherein said at least one restriction prevents exporting said message.

7. The computer-implemented method for recalling an already sent electronic message in accordance with claim 1, wherein:
said at least one restriction is an expiration time;
if a recipient of said message has accessed said message, said message is deleted upon elapse of said expiration time.

8. The computer-implemented method for recalling an already sent electronic message in accordance with claim 1, wherein said at least one restriction limits at least one of: printing said message, forwarding said message, exporting said message, reading said message, and an amount of time said message is stored.

9. The computer-implemented method for recalling an already sent electronic message in accordance with claim 1, wherein said expiration time can be determined in said user equipment.

10. The computer-implemented method for recalling an already sent electronic message in accordance with claim 1, wherein said method provides a means to schedule sending of a message form a user equipment to said first target.

11. The computer-implemented method for recalling an already sent electronic message in accordance with claim 1, wherein said method provides a means to schedule sending of a message form a user equipment to said second target.
